(19) United States
(12) Patent Application Publication
(10) Pub. No.: US 2025/0295260 A1
(43) Pub. Date: Sep. 25, 2025

(54) MULTIPURPOSE COOKING DEVICE AND METHOD THEREOF

(71) Applicant: HCL Technologies Limited, New Delhi (IN)

(72) Inventors: Achal P M Kailash, Bengaluru (IN); Anubhav Sircar, Bengaluru (IN); Kanishk Singh, Bengaluru (IN); Karthikeyan Sabapathy, Bengaluru (IN)

(21) Appl. No.: 18/961,579

(22) Filed: Nov. 27, 2024

(30) Foreign Application Priority Data
Mar. 21, 2024 (IN) 202411021992

(51) Int. Cl. A47J 27/04; A47J 27/00

(52) U.S. Cl. CPC A47J 27/04; A47J 27/002; A47J 2027/043

(57) ABSTRACT

The invention relates to a multipurpose cooking device. The multipurpose cooking device includes a top section. The top section includes a steaming mechanism, a set of heating rods, a convection fan, and a channel, covered within an outer casing of the multipurpose cooking device. The multipurpose cooking device further includes a bottom section. The bottom section includes a turntable plate configured to operate the bottom section in one of a stove mode, or an oven mode. The bottom section includes a set of slots to hold a detachable rack to operate the bottom section in a steam mode. Further the bottom section includes a heating element to provide heat to the turntable plate. The multipurpose cooking device further includes a panoramic glass cover configured to move to an up position and a down position through the channel using a pneumatic gas spring to unlock and lock the bottom section.

### TECHNICAL FIELD

This invention generally relates to the field of home appliances. More specifically, the invention relates to a multipurpose cooking device and method thereof.

### BACKGROUND

In the current era, a significant role of science and technology in worldwide growth is evident, and it influences almost every aspect of our everyday lives. We are so reliant on these technological developments that envisioning a day without their influence seems inconceivable. Notably, in recent years, the realm of kitchen appliances has undergone remarkable advancements, witnessing the evolution of kitchen appliances such as an oven, an induction cooktop, a microwave, a bread toaster, a griller, an electric food steamer, an air fryer, a coffee maker, and the like. In today's fast-paced world, where people do not have enough time to cook their food daily, they either rely on outside cooked food or on these electric kitchen appliances, considering these kitchen appliances may save the time required for cooking food. The ease with which these kitchen appliances can be operated has empowered individuals to take charge of their daily food, even in the midst of hectic schedules. One of the primary advantages of these kitchen appliances lies in their ability to expedite the cooking process. This is because these kitchen appliances are designed to cook food faster than traditional alternatives, saving valuable time for individuals with busy lifestyles.

While the integration of electric kitchen appliances has undeniably revolutionized our cooking experiences, the issue of storage poses a formidable challenge. The modern kitchen, often characterized by limited space, struggles to accommodate the expanding repertoire of these kitchen appliances. As users embrace a myriad of these specialized kitchen appliances, the need for efficient storage solutions becomes increasingly pressing. Additionally, 87% of individuals complain about not having enough storage space in the kitchen. This is because these existing kitchen appliances are used as a single-purpose device. The single-purpose device may occupy more space in the kitchen, which may be one of the major problems for consumers at the present time. Also, a lot of kitchen appliances, e.g., the oven, the food steamer, and so on, are not in use most of the time, and they sit idle in our kitchen space. According to research, having too many kitchen appliances causes decision fatigue in individuals. Additionally, having more kitchen appliances results in higher electricity consumption. Therefore, to address the above-listed drawbacks, there is a growing need for a multifunctional kitchen appliance that will be able to cater to more than one need of the users.

The present invention is directed to overcome one or more limitations stated above or any other limitations associated with the known arts.

### SUMMARY

In one embodiment, a multipurpose cooking device is disclosed. The multipurpose cooking device may include a top section and a bottom section. The top section may include a steaming mechanism for generating steam. It should be noted that the steaming mechanism may further include an in-built water chamber. The top section may further include a set of heating rods and a convection fan configured to cook food evenly. The top section may further include a channel. It should be noted that the steaming mechanism, the set of heating rods, the convection fan, and the channel may be covered within an outer casing of the multipurpose cooking device. The bottom section of the multipurpose cooking device may include a turntable plate placed at a base of the bottom section configured to operate the bottom section in one of a stove mode or an oven mode based on a user requirement. It should be noted that the turntable plate may be configured to remain stationary in the stove mode, and in the oven mode, the turntable plate may be configured to rotate via a motor coupled to the turntable plate. The bottom section may further include a heating element positioned underneath the turntable plate to uniformly heat the turntable plate. The bottom section may further include a set of slots within an inner wall of the outer casing. It should be noted that, a pair of slots of the set of slots may be configured to hold a detachable rack to operate the bottom section in a steam mode. The multipurpose cooking device may further include a panoramic glass cover configured to move to an up position and a down position via the channel using a pneumatic gas spring. It should be noted that, in the up position, the panoramic glass cover may engage with the top section to unlock the bottom section, and in the down position, the panoramic glass cover may engage with the bottom section to lock the bottom section.

In another embodiment, a method of operating a multipurpose cooking device is disclosed. In one example, the method may include receiving a user selection corresponding to one of a stove mode, an oven mode, and a steam mode associated with the multipurpose cooking device. The method may further include enabling an Artificial Intelligence (AI) enabled assistance configured to provide a set of functionalities to a user, upon receiving the user selection. The method may further include assisting, by the AI enabled assistance, the user in real-time to operate the multipurpose cooking device for cooking a selected recipe based on the user selection in response to the enabling.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary multipurpose cooking device, in accordance with some embodiments of the present disclosure.

FIG. 2 illustrates various components of a multipurpose cooking device, in accordance with some embodiments of the present disclosure.

FIG. 3A illustrates a perspective view of a top section of a multipurpose cooking device, in accordance with some embodiments of the present disclosure.

FIG. 3B illustrates an isometric view representing arrangements of components of a bottom section of a multipurpose cooking device, in accordance with some embodiments of the present disclosure.

FIG. 3C illustrates an isometric view depicting a set of heating rods, in accordance with some embodiments of the present disclosure.

FIG. 3D illustrates an isometric view depicting a visual indicator of a multipurpose cooking device, in accordance with some embodiments of the present disclosure.

FIG. 4A-4C is a pictorial depiction representing movement of a panoramic glass cover to an up position and a down position, in accordance with some embodiments of the present disclosure.

FIG. 5 is a pictorial depiction representing an exemplary process of operating of a multipurpose cooking device in different modes, in accordance with some embodiments of the present disclosure.

FIG. 6A represents an exemplary interactive display of a multipurpose cooking device, in accordance with some embodiments of the present disclosure.

FIG. 6B illustrates various messages displayed via an exemplary interactive display, in accordance with some embodiments of the present disclosure.

FIG. 7 illustrates a flowchart of a method of operating a multipurpose cooking device, in accordance with some embodiments of the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

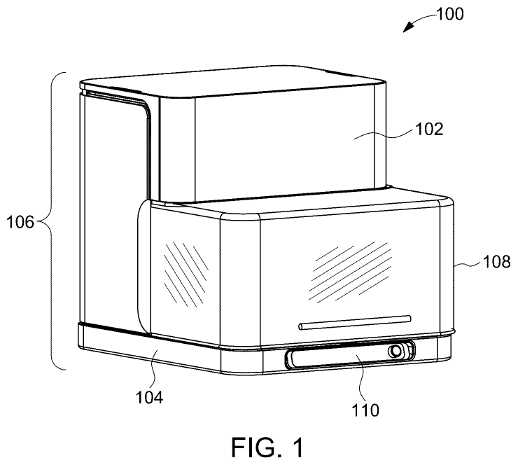

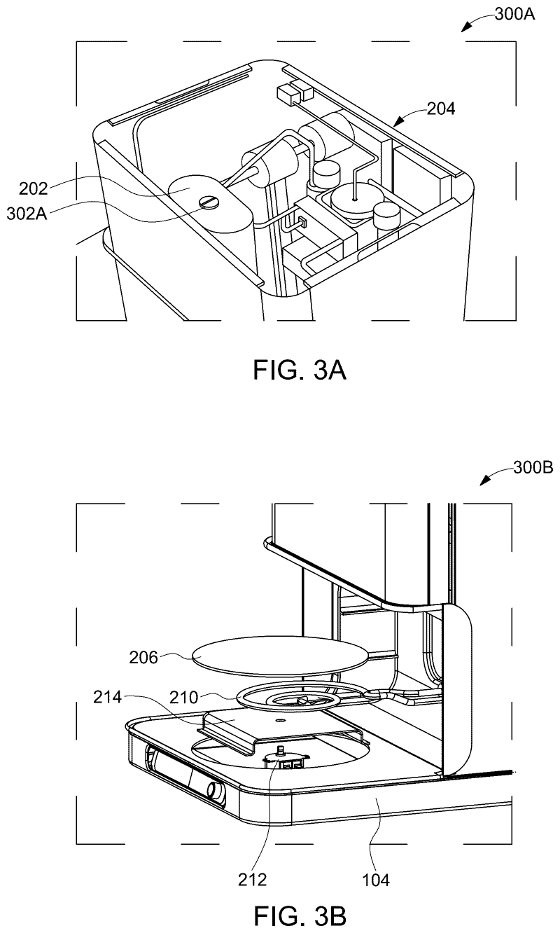

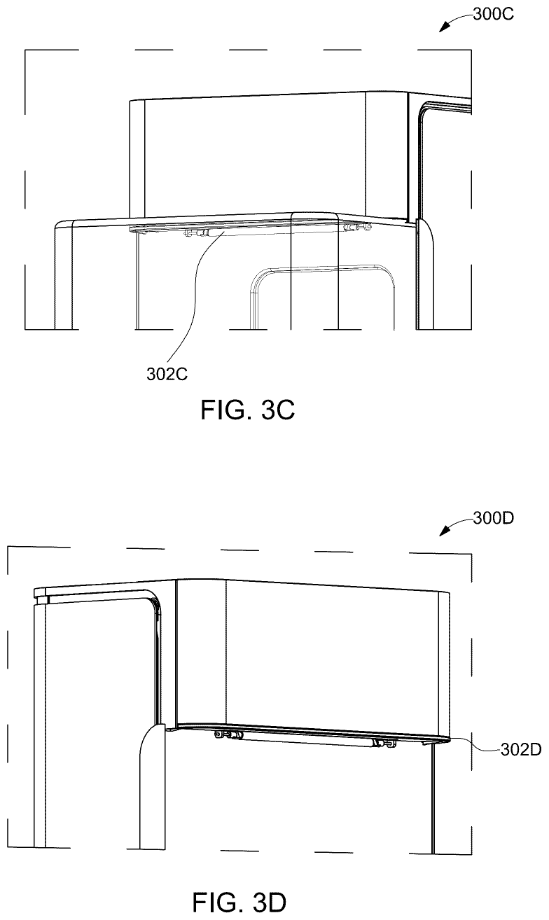

Referring now to FIG. 1, an exemplary multipurpose cooking device 100 is illustrated, in accordance with some embodiments of the present disclosure. The multipurpose cooking device 100 may be configured to function as an oven, a stove, or a food steamer by selecting a corresponding cooking mode from a set of modes according to user requirements. In other words, the multipurpose cooking device 100 may be configured to operate as the oven, the stove, and the food steamer based on the user requirements. In an embodiment, the set of modes may include one of an oven mode, a stove mode, or a steam mode. For example, in order to operate the multipurpose cooking device 100 as the oven, the user may select the oven mode. Similarly, in order to operate the multipurpose cooking device 100 as the stove or the food steamer, the user may select the stove mode or the steam mode, respectively, based on their requirements. In an embodiment, each cooking mode, i.e., the oven mode, the stove mode, and the steam mode of the multipurpose cooking device 100, may be indicated in a pre-defined color using a visual indicator. This is further explained in detail in conjunction with FIG. 3D.

To function in the set of modes, the multipurpose cooking device 100 may include a top section 102 and a bottom section 104. The top section 102 may include a steaming mechanism for generating steam. The steaming mechanism may include an in-built water chamber to generate steam. In particular, in order to operate the multipurpose cooking device 100 in the steam mode, the steaming mechanism may be used to generate steam for cooking food items that require steam to cook. Further, the top section 102 may also include a set of heating rods and a convection fan that are configured to cook food evenly. Examples of the set of heating rods may include, but are not limited to, infrared quartz heating rods, halogen heating rods, calrod heating rods, nichrome heating rods, tungsten heating rods. Additionally, the top section 102 may include a channel. The channel may be used to move a panoramic glass cover 108 to an up position or a down position based on the user requirement.

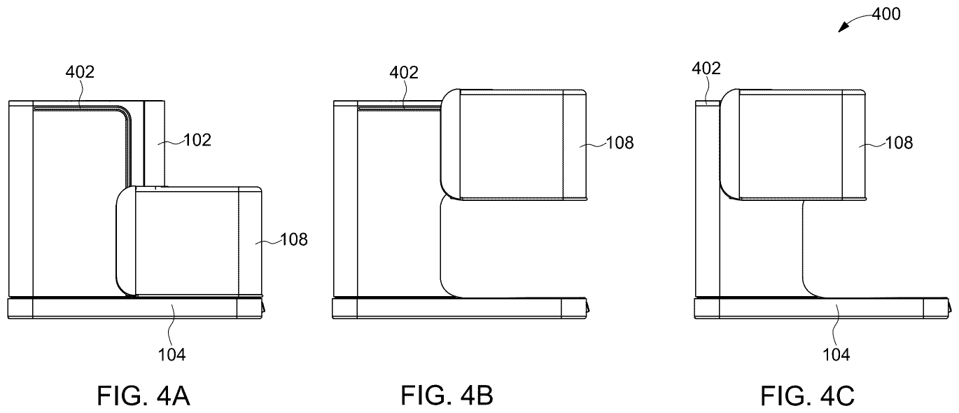

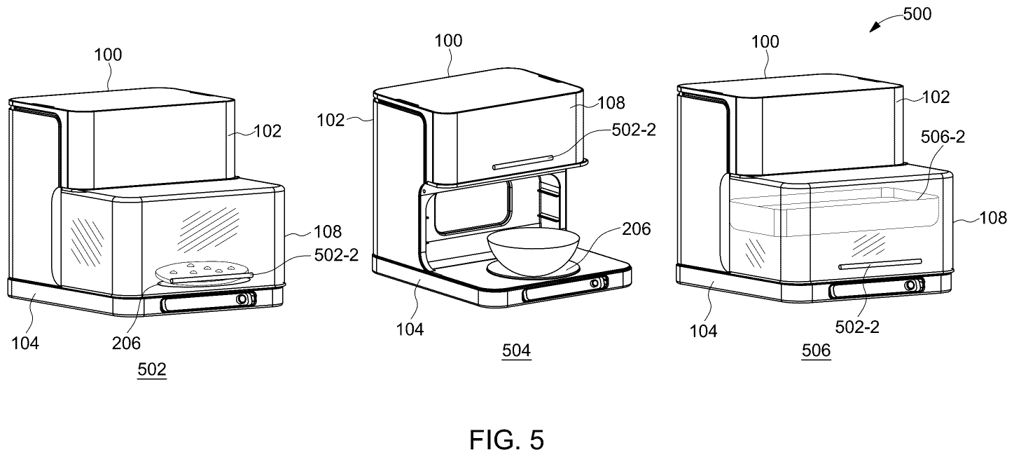

In the up position, the panoramic glass cover 108 may get engaged with the top section 102 to unlock the bottom section 104. The bottom section may be unlocked to operate the multipurpose cooking device 100 in the stove mode. Further, in the down position, the panoramic glass cover 108 may get engaged with the bottom section 104 to lock the bottom section 104. The bottom section 104 may be locked to operate the multipurpose cooking device 100 in one of the oven mode or the steam mode. This is further explained in detail in conjunction with FIGS. 4A-5. It should be noted that the steaming mechanism including the inbuilt water chamber, the set of heating rods, the convection fan, and the channel may be covered within an outer casing 106 of the multipurpose cooking device 100.

Further, the bottom section 104 of the multipurpose cooking device 100 may include a turntable plate placed at a base of the bottom section 104. The turntable plate may be configured to operate the bottom section 104 in one of the stove mode or the oven mode based on the user requirement. The bottom section 104 may further include a heating element (e.g., an induction heating element,) underneath the turntable plate. The heating element may be configured to provide uniform heating to the turntable plate. Further, in the bottom section 104, a set of slots may be inbuilt within an inner side wall of the outer casing 106 to hold a detachable rack. The detachable rack may be attached to a pair of slots of the set slots to operate the bottom section 104 in a steam mode.

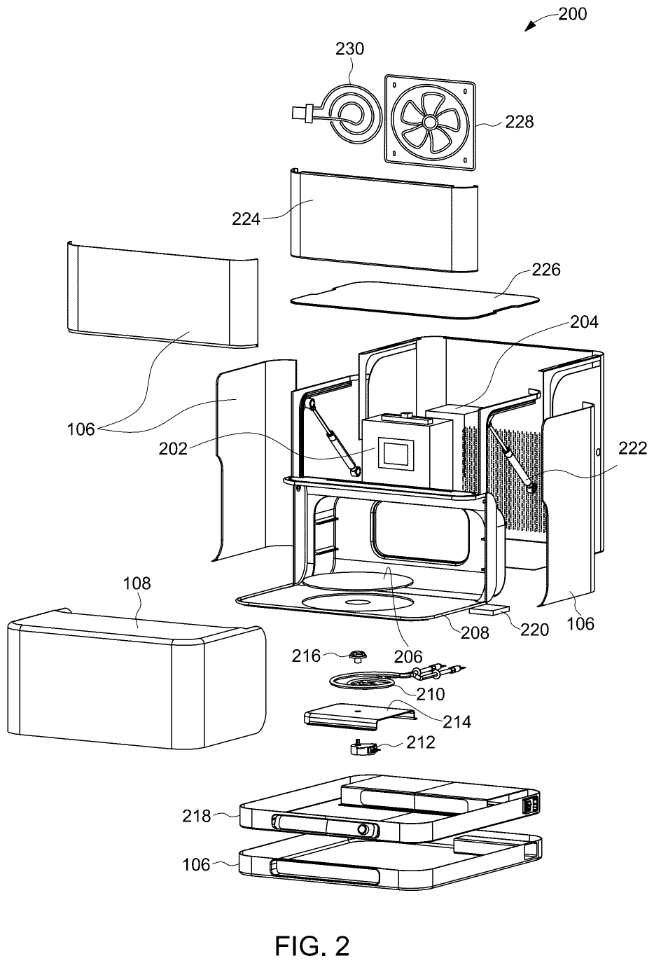

Further, the multipurpose cooking device 100 may include an Artificial Intelligence (AI) enabled assistance. The AI enabled assistance is inbuilt within an interactive display 110. The AI enabled assistance may be configured to provide a set of functionalities to the user. The set of functionalities may include, but are not limited to, an audio interaction, suggesting recipes of a plurality of food items to the user, and guiding the user throughout for a selected recipe. Further, the interactive display 110 may be configured to display messages to the user. For example, the messages may include, but are not limited to, at least one of a selected cooking mode, a list of recipes of the plurality of food items, rendering stepwise procedure of the selected recipe to the user. This is further depicted and explained in detail in conjunction with FIG. 2 to FIG. 7.

Referring now to FIG. 2, various components of the multipurpose cooking device 100 are illustrated via a pictorial depiction 200, in accordance with some embodiments of the present disclosure. FIG. 2 is explained in conjunction with FIG. 1. As depicted via FIG. 2, each component configured for operating the multipurpose cooking device 100 in one of the oven mode, the stove mode, and the steam mode may be covered via the outer casing 106. The outer casing 106 may be made using materials like, for example, stainless steel, plastic, metal alloys, enamel coating, powdered coated steel, etc. Further, as depicted via FIG. 2, the top section 102 of the multipurpose cooking device 100 may include a steaming mechanism for generating steam to operate the multipurpose cooking device 100 in the steam mode.

For this, the steaming mechanism may include an inbuilt water chamber 202 and a steaming system 204. It should be noted that the inbuilt water chamber 202 and the steaming system 204 may be present within a top covering 224. Further, the top covering 224 may be covered via the outer casing 106. Furthermore, the top section 102 may be covered via a top surface 226. In an embodiment, the inbuilt water chamber 202 in conjunction with the steaming system 204 may be configured for generating steam. The inbuilt water chamber 202 may be a refillable water tank. In other words, the inbuilt water chamber 202 may be refilled by the user as and when required, e.g., when the inbuilt water chamber 202 gets empty. The top section 102 may also include the set of heating rods, a convection fan 228, and the channel which are shown and explained in conjunction with FIGS. 3A-4C. In an embodiment, the convection fan 228 may include a heating element 230 that is responsible for generating heat that is circulated as a hot air by the convection fan 228.

Further, as depicted via the present FIG. 2, the bottom section 104 of the multipurpose cooking device 100 may include a turntable plate 206. The turntable plate 206 may be placed at a base 208 of the bottom section 104. Further, a heating element 210 may be positioned underneath the turntable plate 206. The heating element 210, for example, may be an induction heating element. As depicted via the present FIG. 2, the heating element 210 may be present below the base 208 in a way such that the heating element 210 is in alignment with the turntable plate 206. For example, the turntable plate 206 may be an induction plate. As will be appreciated, the heating element 210 may be configured to uniformly heat the turntable plate 206 as per setting defined by the user. In particular, the heating element 210 may be designed (e.g., circular shape, rectangular shape, etc.) in a way such that the turntable plate 210 gets uniformly heated during cooking process to cook food evenly. In some embodiments, instead of the turntable plate 206, a utensil, or a food item that is placed on the turntable plate 206 may be uniformly heated. As will be appreciated, the uniform heating of the turntable plate 210, the utensil or the food item may depend on a type of heating element 206.

It should be noted that turntable plate 206 may be configured to remain stationary when the multipurpose cooking device 100 is operated in the stove mode. Further, the turntable plate 206 may be configured to rotate when the multipurpose cooking device 100 is operated in the oven mode. In the oven mode, the turntable plate may be rotated via a motor 212. The motor 212 may be thermally insulated. As depicted via the present FIG. 2, the motor 212 may be present below a casing 214. In an embodiment, the turntable plate 206 may be coupled to the motor 212 positioned below the casing 214 via a coupling mechanism 216. Further, as depicted via the present FIG. 2, the turntable plate 206 may be coupled to the motor 212 via the coupling mechanism 216 in a such that the heating element 210 gets aligned with the turntable plate 206. In an embodiment, each component, i.e., the heating element 210, the casing 214, and the motor 212, that are present below the base 208 may be positioned within a housing in a bottom covering 218.

Further, as depicted via the present FIG. 2, the bottom covering 218 may be covered via the outer casing 106. In addition, the bottom section 104 of the multipurpose cooking device 100 may include a controller board 220. As will be appreciated, the controller board 220 may enable the functioning of the multipurpose cooking device 100. In other words, the controller board 220 may serve as a brain of the multipurpose cooking device 100. The controller board 220 may control and coordinate and functioning of various components of the multipurpose cooking device 100. By way of an example, the controller board 220 be configured to enable and disable the AI enable assistance, regulate temperature, control speed of the motor 212, and the like. Further, in addition to the above components, in order to assist movement of the panoramic glass cover 110 over the channel (not shown), a pair of pneumatic gas spring (e.g., a pneumatic gas spring 222) may be used. A technique of moving the panoramic glass cover 110 to the up position and the down position is further depicted and explained in conjunction with FIG. 4A-4C. Additional components of the multipurpose cooking device 100 are further depicted and explained in conjunction with FIGS. 3A-3D.

Referring now to FIG. 3A, a perspective view 300A of the top section 102 of the multipurpose cooking device 100 is illustrated, in accordance with some embodiments of the present disclosure. FIG. 3A is explained in conjunction with FIGS. 1 and 2. As depicted via the perspective view 300A, the top section 102 may include the inbuilt water chamber 202 and the steaming system 204. The inbuilt water chamber 202 may be accessible by opening a lid positioned at a top surface (same as the top surface 226) of the multipurpose cooking device 100. As depicted via the perspective view 202, the top surface 226 may be the lid that is removable to access the inbuilt water chamber 202. Further, in some embodiments, the lid may be a small section present on the top surface 222 to access the inbuilt water chamber 202. Furthermore, upon opening the lid, the user may be able to refill the inbuilt water chamber 202 by uncoupling a nozzle 302A. In some another embodiment, the lid may correspond to the nozzle 302A.

Referring now to FIG. 3B, an isometric view 300B representing arrangements of components of the bottom section 104 of the multipurpose cooking device 100 is illustrated, in accordance with some embodiments of the present disclosure. FIG. 3B is explained in conjunction with FIGS. 1-3A. As depicted via the isometric view 300B, the bottom section 104 may include the turntable plate 206. The heating element 210 may be positioned underneath the turntable plate 206. In an embodiment, the turntable plate 206 may correspond to an induction plate. Further, the heating element 210 may correspond to an induction heating element. With reference to FIG. 2, the heating element 210 may be present below the base 208. As depicted via the isometric view 300B, the heating element 210 may be present below the base 208 in a way such that the heating element 210 is in alignment with the turntable plate 206.

As will be appreciated, the heating element 210 may be configured to uniformly heat the turntable plate 206 as per setting defined by the user to cook a food item. It should be noted that the heating element 210 may be designed (e.g., in the circular shape, the rectangular shape, etc.) in a way such that the turntable plate 210 gets uniformly heated during the cooking process to cook food evenly. It should be noted that turntable plate 206 may be configured to remain stationary when the multipurpose cooking device 100 is operated in the stove mode. Further, the turntable plate 206 may be configured to rotate when the multipurpose cooking device 100 is operated in the oven mode. In the oven mode, the turntable plate 206 may be rotated via the motor 212. The motor 212 may be present below the casing 214. Further, the motor 212 may be thermally insulated. It should be noted that, the heating element 210, the casing 214, and the motor 212 may be present within the housing in the bottom covering 218. In addition to the stove mode, the turntable plate 206 may be configured to remain stationary when the multipurpose cooking device 100 is operated in the steam mode. In some embodiments, in the steam mode, the turntable plate 206 may be configured to rotate via the motor 212.

Referring now to FIG. 3C, an isometric view 300C depicting a set of heating rods is illustrated, in accordance with some embodiments of the present disclosure. As will be appreciated the set of heating rods may be present under a bottom surface of the top section 102. By way of an example, an exemplary heating rod 302C (of the set of heating rods) that may be present under the bottom surface of the top section is depicted via the present isometric view 300C. Further, the set of heating rods may be configured to cook the food evenly. In other words, when the multipurpose cooking device 100 is operated in the oven mode, then the set of heating rods may provide uniform heat to cook food from top. Examples of the set of heating rods may include, but are not limited to, infrared quartz heating rods, halogen heating rods, calrod heating rods, nichrome heating rods, tungsten heating rods.

In addition to the set of heating rods, the convection fan 228 may be placed on the bottom surface of the top section 102 adjacent to the set of heating rods. In an embodiment, the convection fan 228 may be strategically placed adjacent to the set of heating rods so that the convection fan 228 may gain its' heat from the set of heating rods. In addition to the set of heating rods, the convection fan 228 (not shown in present FIG. 3C) may be placed on the bottom surface of the top section 102 adjacent to the set of heating rods. In an embodiment, the convection fan 228 may be strategically placed adjacent to the set of heating rods so that the convection fan 228 may gain its' heat from the set of heating rods. Further, the convection fan 228 may circulate hot air around the bottom section 104 when the multipurpose cooking device 100 is operated in the oven mode to ensure uniform heat distribution during the cooking process.

Referring now to FIG. 3D, an isometric view 300D depicting a visual indicator 302D of the multipurpose cooking device 100 is illustrated, in accordance with some embodiments of the present disclosure. FIG. 3D is explained in conjunction with FIGS. 1-3C. The visual indicator 302D may be configured to indicate each of the oven mode, the stove mode, and the steam mode of the multipurpose cooking device 100 in a pre-defined color. In other words, when the multipurpose cooking device 100 may be operated in one cooking mode of the oven mode, the stove mode, and the steam mode, then each cooking mode may be represented via a different color. By way of an example, when the user is operating the multipurpose cooking device 100 in the oven mode, then a color of the visual indicator 302D may represent the oven mode in a red color. By way of another example, when the user is operating the multipurpose cooking device 100 in the stove mode, then a color of the visual indicator 302D may represent the stove mode in a yellow color. By way of yet another example 100, when the user is operating the multipurpose cooking device 100 in the steam mode, then a color of the visual indicator 302D may represent the steam mode in a blue color. The visual indicator 302D may enable the user to easily detect which cooking mode he has selected. In one embodiment, the visual indicator 302D may be configured to indicate activation of the AI enabled assistance. For this, the visual indicator 302D may blink in a pre-defined pattern (e.g., pulsating or fading in and out) to indicate that the AI enabled assistance is listening. The blinking of the visual indicator 302D may provide information to the user that the AI enabled assistance is activated, hence making user experience intuitive. For example, the visual indicator 302D may correspond to a Light Emitting Diode (LED) light strip.

Referring now to FIGS. 4A-4C, a pictorial depiction 400 representing movement of the panoramic glass cover 108 to an up position and a down position is illustrated, in accordance with some embodiments of the present disclosure. FIGS. 4A-4C are explained in conjunction with FIGS. 1-3D. The panoramic glass cover 108 may be configured to move to the up position and the down position. The panoramic glass cover 108 may be configured to move to the up position and the down position to uncover or cover the bottom section 104 of the multipurpose cooking device 100, respectively. In one embodiment, when the bottom section 104 is uncovered, the bottom section 104 may be operated in the stove mode. In another embodiment, when the bottom section is covered, the bottom section 102 may be operated in one of the oven mode or the steam mode. In other words, when the user may want to operate the multipurpose cooking device 100 in the stove mode, then the user may move the panoramic glass cover 108 to the up position to uncover the bottom section 104. Whereas, when the user may want to operate the multipurpose cooking device 100 in one of the oven mode or the steam mode, the user may move the panoramic glass cover 108 to the down position to cover the bottom section 104.

As depicted via FIG. 4A, the panoramic glass cover 108 may be configured to move to the up position and the down position via a channel 402. Further, with reference to FIG. 2, the movement of the panoramic glass cover 108 may be assisted through the pneumatic gas spring 222. The pneumatic gas spring 222 may make the panoramic glass cover 108 feel light and may make motion of the panoramic glass cover 108 smooth while lifting and sliding the panoramic glass cover 108 over the channel 402 using a handle (not shown). As will be appreciated, the handle may be attached to the panoramic glass cover 108 to enable the user to lift the panoramic glass cover 108 based on their requirement. Further, as depicted via the FIG. 4A, when the user may be operating the multipurpose cooking device 100 in one of the oven mode or the steam mode, the panoramic glass cover 108 may get engaged to the bottom section 104. This is done in order to lock the bottom section 104 or cover the bottom section 104 to evenly cook the food during the oven mode and the steam mode.

It should be noted that, the panoramic glass cover 108 may be a cover (e.g., a see-through cover) to enable the user to monitor cooking process of the food. Further, when the user may want to use the multipurpose cooking device in the stove mode the user may lift the panoramic glass cover 108 using the handle as depicted via FIG. 4B. Further, the user may slide the panoramic glass cover 108 over the channel 402 to unlock the bottom section 104 such that the panoramic glass cover gets engaged to the top section 102 as depicted via FIG. 4C. In particular, when the panoramic glass cover 108 gets engaged with the top section 102, the bottom section 104 may get uncovered in order to enable the user to use the bottom section 104 in the stove mode.

Referring now to FIG. 5, a pictorial depiction 500 representing an exemplary process of operating of the multipurpose cooking device 100 in different modes is illustrated, in accordance with some embodiments of the present disclosure. FIG. 5 is explained in conjunction with FIGS. 1-4C. As already explained above in FIGS. 1-4C, the multipurpose cooking device 100 may be configured to operate in the set of modes, i.e., the oven mode, the stove mode, and the steam mode, based on the user requirements. By way of an example, consider a scenario where the user may want to bake a pizza. In this scenario, the user may select the oven mode of the multipurpose cooking device 100 to bake the pizza. Upon selecting the oven mode, the user may place an uncooked prepared pizza at the turntable plate 206. Further, the user may close the panoramic glass cover 108 via a handle 502-2 such that the panoramic glass cover 108 gets engaged to the bottom section 104 as depicted via 502. In other words, in the oven mode, the bottom section 104 may get locked with the panoramic glass cover 108.

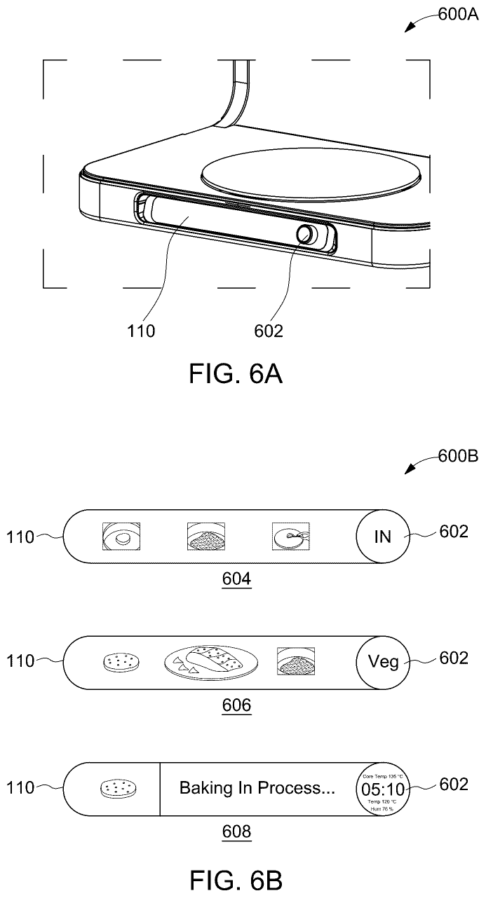

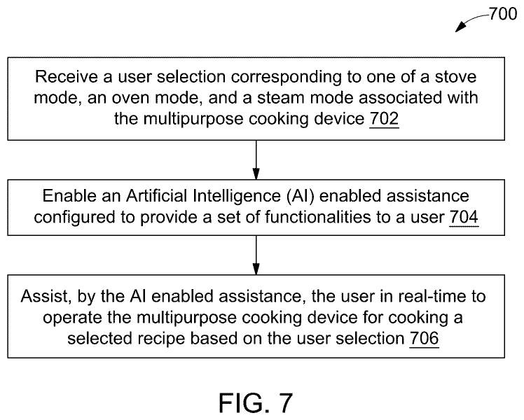

Once the panoramic glass cover 108 gets engaged to the bottom section 104, then the user may initiate baking process for the pizza. The user may initiate the baking process using a smart rotating dial. In some embodiments, the AI enabled assistance may be configured to provide assistance to the user to bake the pizza. This is further explained in detail in conjunction with FIGS. 6 and 7. Once the cooking process is initiated, the turntable plate 206 may be configured to rotate 360 degrees to cook the pizza evenly. The movement of the turntable plate 206 may be assisted via the motor 212. Further, as depicted via the 502, the user may be able to view the baking process through the panoramic glass cover 108, as the panoramic glass cover 108 provides four side visibility view (a front view, a left-side view, a right-side view, and a top view) to the user. Apart from baking the pizza, the oven mode may be used for baking food items like cookies, focaccia, mac n cheese and many more. By way of an example, the oven mode may be depicted via the red color of the visual indicator 302D.

By way of another example, consider a scenario where the user may want to fry vegetables. In this scenario, the user may select the stove mode of the multipurpose cooking device 100 to fry the vegetables. Upon selecting the stove mode, the user may lift and slide the panoramic glass cover 108 via the handle 502-2 such that the panoramic glass cover 108 gets engaged to the top section 102 to uncover the bottom section 104, as depicted via 504. In other words, in the stove mode, the bottom section 104 may get unlocked to provide a hinder free cooking area (i.e., the bottom section 104) for frying the vegetables. Once the panoramic glass cover 108 gets engaged to the top section 102, then the user may place a compatible cooking utensil on the turntable plate 206 as depicted via the step 504. For example, suppose the turntable plate 206 may be the induction plate. In this case, the compatible cooking utensil may be any utensil that is compatible with the induction plate, for example, a stainless-steel pan with flat and smooth bottom, a cast iron pan, etc.

Upon placing the compatible cooking utensil, the user may initiate the cooking process using the smart rotating dial. In other words, the smart rotating dial may be used by the user to adjust the temperature of the turntable plate 206 while frying the vegetables. In some embodiments, the AI enabled assistance may be configured to provide assistance to the user during the cooking process. This is further explained in detail in conjunction with FIGS. 6 and 7. In the stove mode, the turntable plate 206 may be configured to remain stationary. It should be noted that the stove mode may be used by the user to cook foods like pasta, deep fried chicken, curries, flatbread, crepes and the like using cooking methods like deep frying, shallow frying, and griddle. By way of an example, the stove mode may be depicted via the yellow color of the visual indicator 302D.

By way of yet another example, consider a scenario where the user may want to make dumplings. In this scenario, initially the user may select the steam mode of the multipurpose cooking device 100. Upon selecting the steam mode, the user may attach a detachable rack 506-2 to the pair of slots of the set of slots as depicted via 506. Further, the user may place the dumplings for steaming within the detachable rack 506-2. The user may then close the panoramic glass cover 108 via the handle 502-2 such that the panoramic glass cover 108 may get engaged to the bottom section 104 as depicted via 506. In other words, in the steam mode, the bottom section 104 may get locked with the panoramic glass cover 108.

Once the panoramic glass cover 108 gets engaged to the bottom section 104, then the user may initiate the cooking process for the dumplings. The user may initiate the cooking process using the smart rotating dial. In some embodiments, the AI enabled assistance may be configured to provide assistance to the user to make the dumplings. This is further explained in detail in conjunction with FIGS. 6 and 7. Once the cooking process is initiated, the steaming mechanism may generate steam using the inbuilt water chamber 202 to cook the dumplings. Apart from making the dumplings, the steam mode may be used for cooking food items like idli, steamed vegetables, eggs, fish, sushi, and the like. By way of an example, the steam mode may be depicted via the blue color of the visual indicator 302D.

Referring now to FIG. 6A, an exemplary interactive display 110 of the multipurpose cooking device 100 is represented via a pictorial depiction 600A, in accordance with some embodiments of the present disclosure. FIG. 6A is explained in conjunction with FIGS. 1-5. In an embodiment, the interactive display 110 may be an Organic Light Emitting Diode (OLED) display. As will be appreciated, apart from the OLED display, the interactive display 110 may be a Liquid Crystal Display (LCD), a Light Emitting Diode (LED) display, a Quantum Dot LED (QLED) display, an Active-Matrix Organic Light Emitting Diode (AMOLED) display, and the like. As depicted via the present FIG. 6A, the interactive display 110 may be present horizontally in a front end of the bottom section 104. Further, as depicted via the present FIG. 6A, a smart rotating dial 602 may be present adjacent to the interactive display 110. The interactive display 110 may be controlled using the smart rotating dial 602.

Further, the AI enabled assistance may be inbuilt within the interactive display 110. By way of an example, the AI enabled assistance may be a Sous Chef AI assistant. The AI enabled assistance may configure to provide the set of functionalities to the user. The set of functionalities may include the audio interactions, suggesting recipes of a plurality of food items to the user, and guiding the user throughout for a selected recipe. By way of an example, the user may interact with the multipurpose cooking device 100 through voice interactions. In other words, the AI enabled assistance may provide assistance to the user based on audio instructions received from the user. For example, when the user may turn on the multipurpose cooking device 100, then the AI enabled assistance may wake up automatically once configured. In some embodiments, the AI enabled assistance may wake up upon receiving a specific command, e.g., ‘a wake up’ command from the user. In some embodiments, the AI enabled assistance may turn on when the multipurpose cooking device 100 gets started. In other words, the AI enabled assistance may turn on when the multipurpose cooking device 100 is connected to a power slot via a power cable. It should be noted that the multipurpose cooking device 100 may be electrically operable and will start upon connecting the power cable to the power slot. Once the power cable is connected to the power slot, the user may switch on a power button of the multipurpose cooking device 100 to start the multipurpose cooking device 100.

Further, upon receiving the wake-up command, the AI enabled assistance may initiate an interaction with the user via an audio message, for example, ‘how may I assist you?’. Further, the user may request the AI enabled assistance to provide a recipe for a food item (e.g., red kidney beans curry). In this case upon receiving the request, the AI enabled assistance may be configured to guide the user throughout a process of making of the red kidney beans curry through the audio interactions. In some another embodiment, upon waking up, the AI enabled assistance may be configured to suggest recipes of the plurality of food items to the user. Further, the user may select one food item from the plurality of food items and its' recipe, and based on the user selection, the AI enabled assistance will guide user for the selected recipe of the food item.

Further, the interactive display 110 may be configured to display messages to the user. In other words, apart from the audio interactions, the AI enabled assistance may be configured to provide assistance to the user by displaying the messages to the user via the interactive display 110. The messages may include at least one of the selected cooking mode (i.e., the oven mode, the stove mode, or the steam mode), a list of recipes of the plurality of food items, and stepwise procedure of the selected recipe to the user. Further, the smart rotating dial 602 may be configured for displaying a temperature and a time required for cooking the food item. In particular, the smart rotating dial 602 may include an inbuilt screen (e.g., a circular display) for displaying the temperature and the time. In addition to the temperature and the time, the smart rotating dial 602 may display the selected food item and its recipes. This is depicted and explained via FIG. 6B. In other words, once the user may have selected the cooking mode and the food item, then the smart rotating dial 602 may display the temperature and the time required for cooking the food item. In addition to displaying the temperature and the time required for cooking, the smart rotating dial 602 may be used by the user to perform the set of actions. The set of actions may include selection of one of the oven mode, the stove mode, and the steam mode, adjusting the temperature and the timer, and selecting the food item from the plurality of food items.

In other words, using the smart rotating dial 602 the user may select a required cooking mode, for example, the oven mode. Further, the user may use the smart rotating dial 602 to navigate through the plurality of food items to select one food item that the user is interested in cooking. In addition, the user may use the smart rotating dial 602 to adjust the temperature and the timer manually based on their requirement as per the selected food item. For example, when the user is operating the multipurpose cooking device 100 in the stove mode, the user may select the temperature of the turntable plate 206 to fry the vegetables. Along with the temperature, the user may be able to set the timer after which heating of the turntable plate 206 may automatically stop while the user may be frying the vegetable.

Referring now to FIG. 6B, various messages displayed via the exemplary interactive display are illustrated via a pictorial depiction 600B, in accordance with some embodiments of the present disclosure. FIG. 6B is explained in conjunction with FIGS. 1-6A. As explained above in FIG. 6A, initially the user may activate the AI enabled assistance. To activate the AI enabled assistance, the user may press the smart rotating dial 602 for a pre-defined time (e.g., 3 seconds). Once the AI enabled assistance is activated, then the interactive display 110 may be configured to display the plurality of food items to the user. From the plurality of food items, suppose the user may have selected an Indian food item using the smart rotating dial 602 depicted as ‘IN’ via step 604. The selected food item, i.e., ‘IN’ may be displayed via the inbuilt screen of the smart rotating dial 602. In other words, the user may select the Indian food item option by scrolling the smart rotating dial 602. The user may be able to navigate to various recipes of the Indian food items using the smart rotating dial 602.

Further, based on the navigation, suppose the user may have selected a mixed vegetables recipe depicted as ‘Veg’ via step 606. Upon selecting the mixed vegetables recipe, the AI enabled assistance may be configured to guide user through the complete process of cooking the mixed vegetables recipe through the stepwise procedure. For example, the stepwise procedure may include a list of vegetables (e.g., carrots, peas, beans, etc.) along with their quantity required to cook the mixed vegetables recipe (of a pre-defined amount), chopping of vegetables, seasoning required, and the like. In addition to guiding the user, upon receiving the user selection for the mixed vegetables recipe, the smart rotating dial 602 may be configured to display a time and a temperature required for cooking the mixed vegetables recipe, for example as depicted via step 608. Further, the user may be able to adjust the time and the temperature based on their preferences. As will be appreciated, the messages displayed via the interactive display 110 are just an exemplary representation and are not restricted only to these messages.

Referring now to FIG. 7, a method 700 of operating a multipurpose cooking device is illustrated via a flowchart, in accordance with some embodiments of the present disclosure. FIG. 7 is explained in conjunction with FIGS. 1-6B. The multipurpose cooking device may correspond to the multipurpose cooking device 100. Initially, at step 702, a user selection corresponding to one of a stove mode, an oven mode, and a steam mode associated with the multipurpose cooking device 100 may be received. In an embodiment, each of the stove mode, the oven mode, and the steam mode is indicated in a pre-defined color via a visual indicator (same as the visual indicator 302D).

Upon receiving the user selection, at step 704, an Artificial Intelligence (AI) enabled assistance may be enabled. The AI enabled assistance may be enabled to provide a set of functionalities to a user. The set of functionalities may include, but are not limited to, enabling audio interactions, suggesting recipes of a plurality of food items to the user, and guiding the user throughout the selected recipe. Further, at step 706, the AI enabled assistance may assist the user in real-time to operate the multipurpose cooking device 100 for cooking a selected recipe based on the user selection. In an embodiment, the AI enabled assistance may be configured to display messages to the user via an interactive display (same as the interactive display 110). In an embodiment, the messages may include at least one of a selected cooking mode, a list of recipes of the plurality of food items, rendering stepwise procedure of the selected recipe to the user.

By way of an example, consider a scenario where the user may be interested in baking a cake. In this scenario, once the user may have plugged in the multipurpose cooking device 100, then the user may select an appropriate cooking mode, e.g., the oven mode using the smart rotating dial 602, based on his cooking preference. Upon selecting the oven mode, the AI enabled assistance may guide the user through a stepwise procedure of baking the cake. For example, once the AI enabled assistance is triggered after turning on the multipurpose cooking device 100, then the user may interact with the AI enabled assistance, e.g., using the audio interaction. In this scenario, once the AI enabled assistance is triggered, the user may ask the AI enabled assistance to guide him through the recipe of baking the cake using a command, e.g., ‘guide me through the recipe of the cake’. In this case, upon receiving the command, the AI enabled assistance may guide the user using the stepwise procedure of baking the cake. The AI enabled assistance may guide the user either by interacting with the user in real-time using the audio interactions or by displaying the messages depicting steps of baking the cake via the interactive display 110. This has been already explained in detail in conjunction with FIGS. 6A and 6B.

As will also be appreciated, some of the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

Various embodiments provide a multipurpose cooking device. The disclosed multipurpose cooking device may include a top section including a steaming mechanism for generating steam. The steaming mechanism may include an inbuilt water chamber. The top section may further include a set of heating rods and a convection fan configured to cook food evenly. The top section may further include a channel. The steaming mechanism, the set of heating rods, the convection fan, and the channel may be covered within an outer casing of the multipurpose cooking device. Further, the disclosed multipurpose cooking device may include a bottom section. The bottom section may include a turntable plate placed at a base of the bottom section configured to operate the bottom section in one of a stove mode or an oven mode based on a user requirement, In the stove mode, the turntable plate may be configured to remain stationary. In the oven mode, the turntable plate may be configured to rotate via a motor coupled to the turntable plate. The bottom section may further include a heating element positioned underneath the turntable plate to uniformly heat the turntable plate. The bottom section may further include a set of slots within each of an inner side wall of the outer casing at the bottom section. A pair of slots of the set of slots may be configured to hold a detachable rack to operate the bottom section in a steam mode. Additionally, the disclosed multipurpose cooking device may include a panoramic glass cover configured to move to an up position and a down position via the channel using a pneumatic gas spring. In the up position, the panoramic glass cover may engage with the top section to unlock the bottom section. In the down position, the panoramic glass cover may engage with the bottom section to lock the bottom section.

Thus, the present disclosure may overcome drawbacks of traditional electric kitchen appliances. The present disclosure discloses a multipurpose cooking device that may cater to diverse needs of users with respect to different food items using a single device. In other words, the disclosed multipurpose cooking device may provide convenience to users while cooking, as the disclosed multipurpose cooking device is a smart three-in-one solution that can be used as an oven, a stove, and a steamer by selecting a corresponding cooking mode (such as an oven mode, a stove mode, and a steam mode) for steaming food, heating food, cooking food, baking food, and the like. Further, the disclosed multipurpose cooking device may eliminate the need for multiple different electric cooking appliances in kitchen space of the users, thereby saving storage space within a kitchen. In addition, the disclosed multipurpose cooking device may reduce resources required for manufacturing multiple electric kitchen appliances on a global scale. This in turn may reduce manufacturing costs and save our environment from any negative impact that might occur due to the manufacturing of multiple electric kitchen appliances.

In light of the above-mentioned advantages and the technical advancements provided by the disclosed method and device, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described a multipurpose cooking device and method of operating the multipurpose cooking device. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, non-volatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A multipurpose cooking device comprising:
a top section comprising:
a steaming mechanism for generating steam, wherein the steaming mechanism comprises an inbuilt water chamber;
a set of heating rods and a convection fan configured to cook food evenly; and
a channel, wherein the steaming mechanism, the set of heating rods, the convection fan, and the channel are covered within an outer casing of the multipurpose cooking device;
a bottom section comprising:
a turntable plate placed at a base of the bottom section configured to operate the bottom section in one of a stove mode or an oven mode based on a user requirement, wherein, in the stove mode, the turntable plate is configured to remain stationary, and wherein, in the oven mode, the turntable plate is configured to rotate via a motor coupled to the turntable plate;
a heating element positioned underneath the turntable plate to uniformly heat the turntable plate; and
a set of slots within each of an inner side wall of the outer casing at the bottom section, wherein a pair of slots of the set of slots is configured to hold a detachable rack to operate the bottom section in a steam mode; and
a panoramic glass cover configured to move to an up position and a down position via the channel using a pneumatic gas spring, wherein in the up position, the panoramic glass cover engages with the top section to unlock the bottom section, and wherein, in the down position, the panoramic glass cover engages with the bottom section to lock the bottom section.

2. The multipurpose cooking device of claim 1, wherein the panoramic glass cover slides through the channel to move the panoramic glass cover to the up position or the down position to uncover or cover the bottom section of the multipurpose cooking device, respectively.

3. The multipurpose cooking device of claim 2, wherein the bottom section is operated in the stove mode when the bottom section is uncovered, and wherein the bottom section is operated in one of the oven mode or the steam mode when the bottom section is covered.

4. The multipurpose cooking device of claim 1, wherein the base comprises a housing for the motor and the heating element, and wherein the motor is thermally insulated.

5. The multipurpose cooking device of claim 1, further comprising an Artificial Intelligence (AI) enabled assistance, wherein the AI enabled assistance is configured to provide a set of functionalities to a user.

6. The multipurpose cooking device of claim 5, wherein the set of functionalities comprises enabling audio interactions, suggesting recipes of a plurality of food items to the user, and guiding the user throughout for a selected recipe.

7. The multipurpose cooking device of claim 5, wherein the AI enabled assistance is inbuilt within an interactive display configured to display messages to the user, and wherein the messages include at least one of a selected cooking mode, a list of recipes of the plurality of food items, rendering stepwise procedure of the selected recipe to the user.

8. The multipurpose cooking device of claim 7, wherein the interactive display is controlled using a smart rotating dial positioned adjacent to the interactive display.

9. The multipurpose cooking device of claim 8, wherein the smart rotating dial is configured for displaying a temperature and a time required for cooking a food item, and wherein the smart rotating dial is used by the user to perform a set of actions.

10. The multipurpose cooking device of claim 9, wherein the set of actions include selecting one of the stove mode, the oven mode, and the steam mode, adjusting the temperature and the timer, and selecting the food item from the plurality of food items.

11. The multipurpose cooking device of claim 1, wherein the in-built water chamber is refillable by opening a lid positioned at a top surface of the multipurpose cooking device.

12. The multipurpose cooking device of claim 1, further comprising a visual indicator to indicate each of the stove mode, the oven mode, and the steam mode in a pre-defined color.

13. A method of operating a multipurpose cooking device, the method comprising:
receiving, by the multipurpose cooking device, a user selection corresponding to one of a stove mode, an oven mode, and a steam mode associated with the multipurpose cooking device;
upon receiving the user selection, enabling, by the multipurpose cooking device, an Artificial Intelligence (AI) enabled assistance configured to provide a set of functionalities to a user; and
in response to the enabling, assisting, by the AI enabled assistance of the multipurpose cooking device, the user in real-time to operate the multipurpose cooking device for cooking a selected recipe based on the user selection.

14. The method of claim 13, wherein each of the stove mode, the oven mode, and the steam mode is indicated in a pre-defined color via a visual indicator.

15. The method of claim 13, wherein the set of functionalities comprises enabling audio interactions, suggesting recipes of a plurality of food items to the user, and guiding the user throughout for the selected recipe.

16. The method of claim 13, wherein assisting by the AI enable assistance comprises:
displaying messages to the user via an interactive display, and wherein the messages include at least one of a selected cooking mode, a list of recipes of the plurality of food items, rendering stepwise procedure of the selected recipe to the user.
